(19) United States
(12) Patent Application Publication
(10) Pub. No.: US 2026/0348392 A1
(43) Pub. Date: Nov. 5, 2026

(54) COMPOSITION FOR AN ABRADABLE SEAL FOR A TURBOMACHINE

(71) Applicant: SAFRAN AERO BOOSTERS, Herstal (BE)

(72) Inventor: Laurent SCHUSTER, Herstal (BE)

(21) Appl. No.: 19/121,212

(22) PCT Filed: Oct. 18, 2023
(86) PCT No.: PCT/EP2023/079011

§ 371 Date: Apr. 15, 2025

(30) Foreign Application Priority Data
Nov. 9, 2022 (BE) BE2022/5903

(51) Int. Cl. F04D 29/16; C22C 32/00; F04D 29/02

(52) U.S. Cl. CPC F04D 29/164; C22C 32/0094; F04D 29/023

(57) ABSTRACT

A composition for an abradable seal for a compressor. The composition including a metallic phase and a non-metallic phase. The latter constituting 5 to 50% of the total mass of the composition, the metallic phase comprising, by mass: 45% to 80% of aluminum; 10% to 45% of nickel; 5% to 20% of cobalt or chromium; and 1 to 5% of copper, magnesium, manganese or zirconium. A method for producing the seal and to the turbomachine including this seal.

### TECHNICAL FIELD

The invention relates to the field of sealing turbomachines using a two-phase abradable seal. The invention also proposes a method for producing an abradable seal and a turbomachine equipped with this seal.

### PRIOR ART

Climate change is a major concern for many legislative and regulatory bodies around the world. Indeed, various carbon emission restrictions have been, are being, or will be adopted by various states. In particular, an ambitious standard applies to both new aircraft types and those already in operation, requiring the implementation of technological solutions to ensure their compliance with current regulations. Civil aviation has been mobilizing for several years now to contribute to the fight against climate change.

Technological research efforts have already led to very significant improvements in the environmental performance of aircraft. The Applicant takes into consideration the impact factors in all phases of design and development to obtain less energy-intensive, more environmentally friendly aeronautical components and products whose integration and use in civil aviation have moderate environmental consequences with the aim of improving the energy efficiency of aircraft.

Consequently, the Applicant is constantly working to reduce its negative climate impact by using methods and operating virtuous development and manufacturing processes and minimizing greenhouse gas emissions to the minimum possible in order to reduce the environmental footprint of its activity.

This sustained research and development work focuses on new generations of aircraft engines, the weight reduction of aircraft, particularly through the materials used and lighter on-board equipment, the development of the use of electrical technologies to ensure propulsion, and, as an essential complement to technological progress, aeronautical biofuels.

In this context, the invention relates more particularly to the aspects related to the sealing of the air stream. Indeed, within the primary stream, the clearance between the radial ends of the rotating blades and the casing can be the location of leaks or vortices, leading to a reduction in the efficiency of the turbomachine, and consequently higher consumption for equal power delivered.

To reduce these leaks, it is imperative to bring the blades closer to the casing while maintaining a safety margin. Indeed, in the event of contact, both the blades and the casing can be damaged, and jeopardize the operational safety of the turbomachine. These cases remain commonplace due to vibrations, ingestion, centrifugal force, expansion, and rotor misalignment in particular. Therefore, adding a layer of abradable material to the interface between the casing and the blades makes it possible to control damage in the event of contact since the degradation is concentrated in the material of the seal which is intended to crumble.

Documents EP 3 023 511 A1 and EP 3 444 443 A1 disclose compositions for abradable turbomachine seals. These compositions aim to maximize the durability of abradable seals.

The inventors have highlighted the fact that corrosion is not completely eliminated with these compositions, particularly when the substrate on which these seals are deposited is made of a material sensitive to corrosion. Also, the inventors have observed wear due to erosion due to the air flow which rubs against the abradable seal. This erosion appears especially under the high pressure and temperature conditions allowed by the new generations of turbomachines, which are more compact, more powerful and more frugal.

### DESCRIPTION OF THE INVENTION

### Technical Problem

The objective of the invention is to propose a composition for an abradable seal that overcomes the aforementioned disadvantages, particularly by providing better resistance to corrosion (regardless of the substrate on which the seal is deposited) and erosion, especially at high temperatures.

### Technical Solution

The invention relates to a composition for an abradable seal of a turbomachine compressor, the composition comprising a metallic phase and a non-metallic phase, the latter constituting 5 to 50% of the total mass of the composition, the metallic phase comprising, by mass: 45% to 80% aluminum; 10% to 45% nickel; 5% to 20% cobalt or chromium; and 1 to 5% copper, magnesium, manganese, or zirconium.

By “abradable” or “abradable seal,” it is meant a material capable of crumbling upon contact with a rotor element of a turbomachine.

The presence, in combination, of cobalt or chromium in a rate between 5 and 20% on one hand, and traces of copper, magnesium, manganese, or zirconium on the other hand, has been demonstrated by the inventors to be beneficial for improving resistance to erosion, particularly at high temperatures (above 150 °C).

The composition can be in the form of a powder, with the metallic phase and the non-metallic phase each forming distinct grains. Depending on the composition of the phase, the addition of a binding agent between the two phases is used. The two phases are then intimately mixed to be uniformly dispersed.

According to an advantageous embodiment of the invention, the metallic phase comprises 5 to 17% cobalt.

According to an advantageous embodiment of the invention, the metallic phase comprises 15% cobalt and 4% zirconium.

According to an advantageous embodiment of the invention, the mass of cobalt or chromium, combined with the mass of copper, magnesium, manganese, or zirconium, is between 10% and 22% of the mass of the metallic phase.

According to an advantageous embodiment of the invention, the non-metallic phase comprises, by mass, between 30% to 35% of one or more of the following elements: polyester, methyl-methacrylate, hexagonal boron nitride, calcium fluoride, graphite, bentonite, talc, or molybdenum disulfide.

According to an advantageous embodiment of the invention, the nickel and cobalt, or the nickel and chromium, do not exceed, together, 45% of the mass of the metallic phase. This prevents premature wear of the abradable material.

The invention also relates to a method for producing an abradable seal of an axial turbomachine, the method comprising the deposition of a composition according to one of the above embodiments by plasma spraying on an internal surface of a ferrule or a compressor casing element.

The invention also relates to a turbomachine comprising a low-pressure compressor with a row of rotor blades and an abradable seal surrounding the row of rotor blades, remarkable in that the seal is formed by the method described above.

Indeed, the mass proportions of the different elements are not altered by the deposition process, and a seal obtained by the method of the invention is therefore distinct from a seal obtained by a process implementing another composition.

### BRIEF DESCRIPTION OF THE DRAWINGS

FIG. 1 illustrates a sectional view of a turbomachine compressor.

### DETAILED DESCRIPTION

In the following description, the terms “internal” and “external” refer to a positioning relative to the axis of rotation of an axial turbomachine. The axial direction corresponds to the direction along the axis of rotation of the turbomachine. The radial direction is perpendicular to the axis of rotation. Upstream and downstream are in reference to the main flow direction of the flux in the turbomachine.

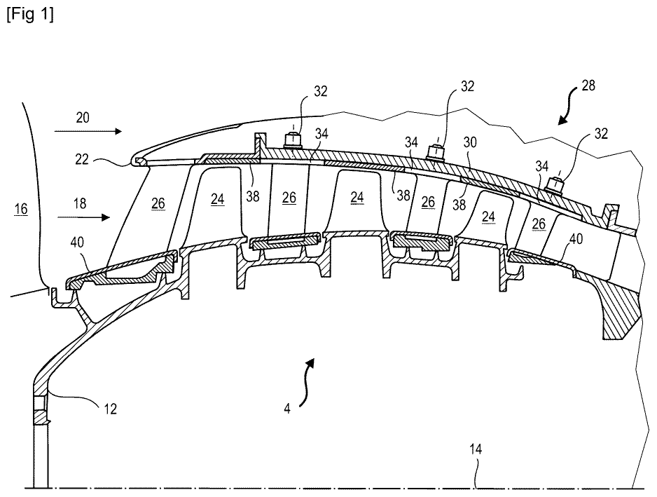

The dimensions of FIG. 1 are not to scale, and in particular, the thicknesses or radial dimensions are exaggerated to facilitate reading the figures.

FIG. 1 represents a cross-sectional view of a compressor 4 of an axial turbomachine.

Preferably, the compressor 4 corresponds to a low-pressure compressor. The turbomachine further comprises other components not shown in FIG. 1, such as a high-pressure compressor, a combustion chamber, and one or more turbine stages. The turbine(s) drive a rotor 12 in rotation. The rotor supports several rows of rotor blades 24 associated with rows of stator blades 26. The rotation of the rotor 12 around its axis of rotation 14 thus allows compressing an air flow progressively up to the entrance of the combustion chamber.

A fan 16 (partially illustrated) is coupled to the rotor 12 and generates an air flow that divides into a primary flow 18 and a secondary flow 20. The primary flow 18 and secondary flow 20 are separated by a splitter nose 22.

The rotor blades 24 can extend radially from a rotor support which can be a dovetail platform, an internal crown of a bladed drum, or any other type of composite rotor support.

The stator blades 26 extend essentially radially from an external casing 28, 30. They can be fixed and immobilized there using fixing axes 32 and platforms 34. They radially traverse the primary flow 18 up to an internal ferrule 40.

The turbomachine can be a multi-flow turbomachine. We will focus on one of these flows, defined by an air vein. Thus, the air vein concerned by the invention can be a primary air vein, compressing the air intended to enter the combustion chamber; a secondary air vein, propelled by a ducted fan; or a tertiary air vein originating from the primary vein and joining a secondary flow of an unducted turbofan (CROR “Counter-Rotating Open Rotor” or USF “Unducted Single Fan”).

A layer of abradable material or abradable seal 38 is deposited facing the radial end of the rotor blades 24.

The wall 30 thus serves as a support for the fixing platforms 34 of the stator blades 26 and as a support for the abradable seals 38 ensuring dynamic seals around the rotor blades 24. A dynamic seal is understood as a limitation of the flow between the abradable seal and a rotor blade rotating during the operation of the turbomachine. The radially internal surface of the abradable seal 38 is flush with the radially internal surface of the platforms 34. The abradable seals 38 form homogeneous annular layers, such as circular ribbons whose thicknesses can be greater than 2.00 mm.

While the invention favors the positioning of an abradable seal in the compressor, the teaching of the invention can also be adapted to any rotating element, such as baffles or labyrinth seals. Thus, the internal surface of the ferrules 40 can also contain an abradable material of similar or different composition to the abradable seal 38. The composition of the invention can also be implemented at the level of the turbines, given its heat resistance.

The casing 28, and notably its wall 30, can be made of a composite material with an organic matrix. The composite material can include an epoxy resin and a preform with a stack of carbon fiber plies woven in three dimensions. Alternatively, the casing can be made of metal, such as a titanium or aluminum alloy.

The composition of the material forming the abradable seal 38 can include two mixed phases, namely a metallic phase and a non-metallic phase. The non-metallic phase can be mineral and/or organic. The abradable seal can be composite; and/or granular; and/or can contain spaces filled by some of its constituents. The composition can be in the form of a powder, with the metallic phase and the non-metallic phase each forming distinct grains. Alternatively, the non-metallic phase can form inclusions (nodules) in grains predominantly formed of the metallic phase. The non-metallic phase can form a lubricant.

The non-metallic phase can represent 5 to 50%, preferably 15% to 25%, and more preferably 20%, of the total mass of the composition. The metallic phase can form the remaining weight, namely 50 to 95% of the total weight, preferably 75 to 85%, and more preferably 80%, of the total mass of the composition.

The metallic phase can represent the majority of the volume of the abradable seal layer, thus, the metallic phase can form a matrix receiving the second phase.

Optionally, the abradable seal layer can be formed of metallic powder grains whose inter-grain spaces are filled by the second phase.

The metallic phase primarily comprises aluminum. That is to say, among the metals of the abradable seal, the one with the most significant mass is aluminum. The predominance of aluminum favors a good compromise between the mass of the seal, corrosion resistance, and mechanical strength.

The metallic phase of the abradable coating 38 also includes nickel, in a mass proportion lower than that of aluminum. The mass proportions of nickel and aluminum in the metallic phase are: 10% to 45%, preferably 25% to 30% nickel; and 45% to 80%, preferably 70% to 75% aluminum.

Furthermore, the metallic phase comprises between 5% and 20% chromium, or between 5% and 20% cobalt, or between 5% and 20% combined mass of chromium and cobalt. This range can preferably be restricted to 10% to 17%.

Additionally, the metallic phase comprises between 1% and 5% copper, magnesium, manganese, and/or zirconium. When two of these elements are present, their combined mass falls within this interval. In a variant, the rate of these elements can be present in trace amounts.

Preferably, the chromium and/or cobalt, on one hand, and the copper, magnesium, manganese, and/or zirconium, on the other hand, together constitute between 10% and 22% of the metallic phase, preferably between 16% and 18%.

The non-metallic phase can comprise one or more organic materials, and/or one or more mineral materials.

For example, the non-metallic phase can contain, by mass, 15% to 35%, and preferably 30% to 35% of one or more of the following elements: polyester, methyl-methacrylate, hexagonal boron nitride, calcium fluoride, graphite, bentonite, talc, or molybdenum disulfide.

The non-metallic phase can also contain a resin (ketone or phenol).

The non-metallic phase can also include a binding agent to bind the metallic phase to the non-metallic phase.

The described composition can be applied to the casing by plasma spraying. Such a thermal technique is notably known from document EP 1 010 861 A2. The powder constituting the non-metallic phase can be introduced into the plasma jet downstream of the powder constituting the metallic phase. Other techniques are conceivable: the composition can be applied to the support by sintering, possibly with prolonged heating.

During the deposition of the abradable layer, some grains may melt and then solidify. The initial mass ratios remain the same on the final layer, making it possible to distinguish it from a layer obtained from a different composition.

1. A composition for an abradable seal of a turbomachine compressor, the composition comprising a metallic phase and a non-metallic phase, the non-metallic phase constituting 5 to 50% of a total mass of the composition, wherein the metallic phase of the composition comprises, by mass:
45% to 80% aluminum;
10% to 45% nickel;
5% to 20% cobalt or chromium;
1 to 5% copper, magnesium, manganese, or zirconium; and
5 to 17% cobalt.

2. (canceled)

3. The composition according to claim 1, wherein the metallic phase comprises 15% cobalt and 4% zirconium.

4. The composition according to claim 1, wherein the mass of cobalt or chromium, combined with the mass of copper, magnesium, manganese, or zirconium, is between 10% and 22% of the mass of the metallic phase.

5. The composition according to claim 1, wherein the non-metallic phase comprises, by mass, between 30% to 35% of one or more of the following elements: polyester, methyl-methacrylate, hexagonal boron nitride, calcium fluoride, graphite, bentonite, talc, or molybdenum disulfide.

6. The composition according to claim 1, wherein the nickel and cobalt, or the nickel and chromium, do not exceed, together, 45% of the mass of the metallic phase.

7. A method for producing the abradable seal of the turbomachine compressor, the method comprising:
deposition of the composition according to claim 1 by plasma spraying on an internal surface of a ferrule or a compressor casing element.

8. The turbomachine comprising the turbomachine compressor with a row of rotor blades and the abradable seal surrounding the row of the rotor blades, wherein the seal is formed by the method of claim 7.
